(19) United States
(12) Patent Application Publication
(10) Pub. No.: US 2022/0230175 A1
(43) Pub. Date: Jul. 21, 2022

(54) METHOD TO BE EXECUTED BY COMPUTER SYSTEM, AND COMPUTER SYSTEM

(71) Applicants: Bacoor dApps Inc., Hyogo (JP); AI SHOJI CO., LTD., Hyogo (JP)

(72) Inventors: Yukio HARUNA, Hyogo (JP); Hitoshi TAKEUCHI, Hyogo (JP)

(73) Assignees: Bacoor dApps Inc., Hyogo (JP); AI SHOJI CO., LTD., Hyogo (JP)

(21) Appl. No.: 17/613,778

(22) PCT Filed: Dec. 11, 2020
(86) PCT No.: PCT/JP2020/046440

§ 371 Date: Nov. 23, 2021

(30) Foreign Application Priority Data
Mar. 19, 2020 (JP) 2020-050245

(51) Int. Cl. G06Q 20/40; G06Q 20/38

(52) U.S. Cl. CPC G06Q 20/407; G06Q 20/389

(57) ABSTRACT

A method of the present disclosure includes: generating, by a computer system, a non-fungible token associated with a digital asset received; and identifying, by the computer system, an owner of the non-fungible token as a transmission destination of the digital asset.

### TECHNICAL FIELD

The present disclosure relates to a method to be executed by a computer system, and the computer system. This application claims priority on Japanese Patent Application No. 2020-50245 filed on Mar. 19, 2020, the entire content of which is incorporated herein by reference.

### BACKGROUND ART

PATENT LITERATURE 1 discloses Ethereum. Ethereum is a platform for building a decentralized application and a smart contract. The smart contract is implemented on a blockchain so as to automatically execute a protocol for contract or the like.

### CITATION LIST

### Patent Literature

PATENT LITERATURE 1: Japanese Laid-Open Patent Publication No. 2019-160316

### SUMMARY OF INVENTION

An aspect of the present disclosure is a method executed by a computer system in order to keep and return a first digital asset that can be transacted.

Another aspect of the present disclosure is a method executed by a computer system.

Another aspect of the present disclosure is a computer system configured to execute a process for keeping and returning a first digital asset that can be transacted.

Another aspect of the present disclosure is a computer system configured to execute a process.

Another aspect of the present disclosure is a method including: generating, by a computer system, a non-fungible token associated with a digital asset received; and identifying, by the computer system, the owner of the non-fungible token as a transmission destination of the digital asset.

Another aspect of the present disclosure is a computer system configured to execute a process. The process includes: generating a non-fungible token associated with a digital asset received; and identifying the owner of the non-fungible token as a transmission destination of the digital asset.

Another aspect of the present disclosure is a computer system configured to execute a generation process and a transmission process for a non-fungible token upon receiving a digital asset from a transmission source via a computer network, or a method thereof.

The present disclosure includes aspects other than above aspects. Further details will be described later as an embodiment.

### BRIEF DESCRIPTION OF DRAWINGS

FIG. 1 is a flowchart of a borrowing and lending process.

FIG. 2 illustrates a network configuration for borrowing and lending.

FIG. 3 illustrates depositing of a collateral in a smart contract.

FIG. 4 illustrates depositing of a loan in the smart contract.

FIG. 5 illustrates lending to a borrower, and fee collection.

FIG. 6 illustrates transmission of a deposit certificate and a loan certificate.

FIG. 7 is a flowchart of a repayment process.

FIG. 8 illustrates transmission of a repayment to the smart contract.

FIG. 9 illustrates return of the collateral, and banning of the deposit certificate.

FIG. 10 illustrates reception of the repayment, and banning of the loan certificate.

FIG. 11 illustrates resale of the deposit certificate.

FIG. 12 illustrates resale of the loan certificate.

FIG. 13 is a flowchart of a process when repayment has not been made.

FIG. 14 illustrates generation of a deposit certificate NFT and a loan certificate NFT.

### DESCRIPTION OF EMBODIMENTS

### <1. Outlines of Method to be Executed by Computer System, and the Computer System>

A digital asset may be temporarily deposited to a third party other than the owner of the digital asset. The digital asset may be deposited as collateral for a borrowing, for example. Moreover, depositing the digital asset may be for receiving a loan. The deposited digital asset will be returned in the future.

In order to enhance the value of the digital asset, even when the digital asset is temporarily deposited to the third party, the right to have the deposited digital asset back (typically, the ownership of the digital asset) is desired to be able to be transacted.

However, if the right to have the deposited digital asset back can be transacted, managing the digital asset is troublesome for the third party in charge of the deposited digital asset. That is, if the right to have the deposited digital asset back can be transacted, the third party in charge of the deposited digital asset needs to manage change in the return destination of the digital asset. Such management is troublesome.

Therefore, the above problem is desired to be solved. In an aspect of the present disclosure, the above problem can be solved by generating a non-fungible token associated with the digital asset, and identifying the owner of the non-fungible token as a return destination of the digital asset.

(1) A method according to an embodiment is a method executed by a computer system in order to keep and return a first digital asset that can be transacted. The method according to the embodiment includes: receiving, by the computer system, the first digital asset transmitted from an account of a user in order to keep the first digital asset for the user; generating, by the computer system, a second non-fungible token that is associated with the first digital asset and whose owner is recorded on a blockchain; transmitting, by the computer system, the second non-fungible token generated to the account of the user; and when the computer system has determined that a return condition for the first digital asset is satisfied, transmitting, by the computer system, the first digital asset to an owner account of the second non-fungible token associated with the first digital asset in order to return the first digital asset.

(2) Preferably, the blockchain is configured to record the owner account of the second non-fungible token, and the computer system is configured to identify the owner account of the second non-fungible token associated with the first digital asset, by referring to the blockchain.

(3) Preferably, the second non-fungible token generated by the computer system includes data related to the first digital asset.

(4) Preferably, the first digital asset is a first non-fungible token whose transaction is recorded on the blockchain.

(5) Preferably, keeping the first digital asset for the user is keeping, by the computer system, the first non-fungible token that is a collateral for repayment of a borrowing that the user borrows.

(6) Preferably, the first digital asset is a first fungible token whose transaction is recorded on the blockchain.

(7) Preferably, keeping the first digital asset for the user is keeping, by the computer system, the first fungible token as a loan that the user lends.

(8) A method according to the embodiment may be a method executed by a computer system. The method according to the embodiment may include: receiving, by the computer system, a first non-fungible token transmitted from an account of a first user in order to keep a collateral for repayment of a borrowing that the first user borrows; receiving, by the computer system, a loan that a second user lends and that is transmitted from an account of the second user, in order to keep the loan; generating, by the computer system, a second non-fungible token that is associated with the first non-fungible token and whose owner is recorded on a blockchain, and a third non-fungible token that is associated with the loan and whose owner is recorded on the blockchain; transmitting, by the computer system, the second non-fungible token generated, as a deposit certificate of the first non-fungible token to the account of the first user; transmitting, by the computer system, the third non-fungible token generated, as a deposit certificate of the loan to the account of the second user; when the computer system has determined that a return condition for the first non-fungible token is satisfied, transmitting, by the computer system, the first non-fungible token to an owner account of the second non-fungible token associated with the first non-fungible token in order to return the first non-fungible token; and when the computer system has determined that a return condition for the loan is satisfied, transmitting, by the computer system, the loan to an owner account of the third non-fungible token associated with the loan in order to return the loan.

(9) A computer system according to the embodiment may be configured to execute a process for keeping and returning a first digital asset that can be transacted. The process may include: receiving, by the computer system, the first digital asset transmitted from an account of a user in order to keep the first digital asset for the user; generating, by the computer system, a second non-fungible token that is associated with the first digital asset and whose owner is recorded on a blockchain; transmitting, by the computer system, the second non-fungible token generated to the account of the user; and when the computer system has determined that a return condition for the first digital asset is satisfied, transmitting, by the computer system, the first digital asset to an owner account of the second non-fungible token associated with the first digital asset in order to return the first digital asset.

(10) A computer system according to the embodiment may be configured to execute a process. The process may include: receiving, by the computer system, a first non-fungible token transmitted from an account of a first user in order to keep a collateral for repayment of a borrowing that the first user borrows; receiving, by the computer system, a loan that a second user lends and that is transmitted from an account of the second user, in order to keep the loan; generating, by the computer system, a second non-fungible token that is associated with the first non-fungible token and whose owner is recorded on a blockchain, and a third non-fungible token that is associated with the loan and whose owner is recorded on the blockchain; transmitting, by the computer system, the second non-fungible token generated, as a deposit certificate of the first non-fungible token to the account of the first user; transmitting, by the computer system, the third non-fungible token generated, as a deposit certificate of the loan to the account of the second user; when the computer system has determined that a return condition for the first non-fungible token is satisfied, transmitting, by the computer system, the first non-fungible token to an owner account of the second non-fungible token associated with the first non-fungible token in order to return the first non-fungible token; and when the computer system has determined that a return condition for the loan is satisfied, transmitting, by the computer system, the loan to an owner account of the third non-fungible token associated with the loan in order to return the loan.

(11) A method according to the embodiment may include: generating, by a computer system, a non-fungible token associated with a digital asset received; and identifying, by the computer system, the owner of the non-fungible token associated with the digital asset, as a transmission destination of the digital asset. Preferably, the computer system transmits the non-fungible token generated to the outside of the computer system.

(12) A computer system according to the embodiment may be configured to execute a process. The process may include: generating a non-fungible token associated with a digital asset received; transmitting the non-fungible token to the outside of the computer system; and identifying the owner of the non-fungible token associated with the digital asset, as a transmission destination of the digital asset.

(13) A computer system according to the embodiment is configured to execute a generation process and a transmission process upon receiving a digital asset from a transmission source via a computer network. Preferably, the generation process includes generating a non-fungible token to be transmitted to the transmission source, the owner of the non-fungible token being recorded on a blockchain, and the transmission process includes transmitting the non-fungible token generated through the generation process to the transmission source. In this case, the transmission source, having transmitted the digital asset to the computer system, can receive and own the non-fungible token. Since the computer system executes, after reception of the digital asset, the generation process for the non-fungible token to be transmitted to the transmission source, the computer system need not have the non-fungible token. That is, if the generation process, which is triggered by reception of the digital asset, is not provided, the computer system needs to have multiple non-fungible tokens for transmission in advance. However, since the computer system according to the embodiment generates the non-fungible token after reception of the digital asset, the computer system need not have multiple non-fungible tokens for transmission in advance.

(14) Preferably, the above generation process includes acquiring data to be added to the non-fungible token, and the non-fungible token generated through the generation process includes the data acquired.

(15) Preferably, the data includes an image to be added to the non-fungible token.

(16) Preferably, the data includes information related to a non-fungible token as the digital asset.

(17) Preferably, the data is determined according to the digital asset received.

<2. Method to be Executed by Computer System for Keeping and Returning Digital Asset, and the Computer System>

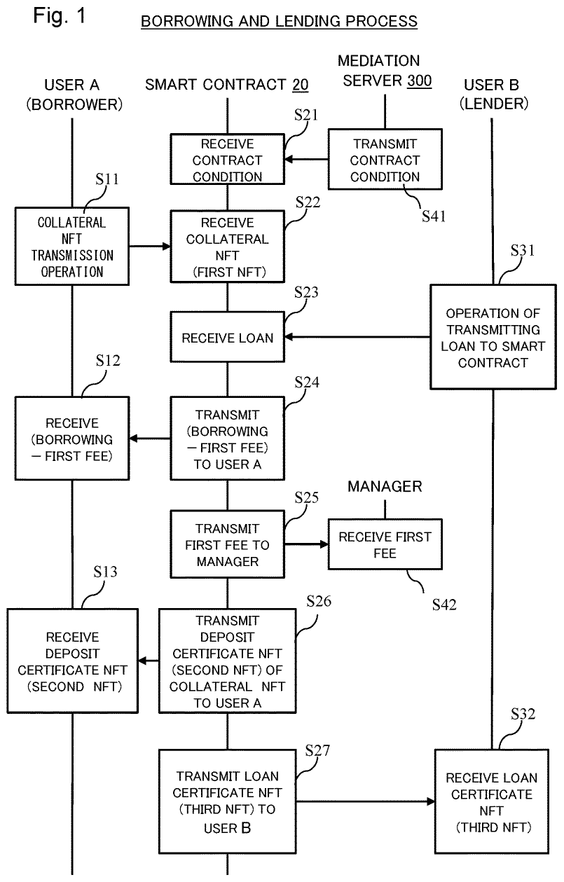

FIG. 1 shows a procedure of a method executed by a computer system for keeping and returning a digital asset. The method executed by a computer system for keeping and returning a digital asset is implemented on a computer system. In other words, this method is implemented on the computer system and executed by the computer system.

The computer system is configured to execute a process for keeping and returning a digital asset. This process is executed according to a program installed in one or a plurality of computers constituting the computer system. The number of computers constituting the computer system may be one or more. The plurality of computers are connected to each other via a network, and execute the process for keeping and returning a digital asset in cooperation with each other. The plurality of computers connected via the network may be called a computer network.

FIG. 1 shows an example of a procedure of a process of managing borrowing and lending (borrowing and lending process), as an example of the process for keeping and returning a digital asset. The borrowing and lending process shown in FIG. 1 is executed by a smart contract, for example.

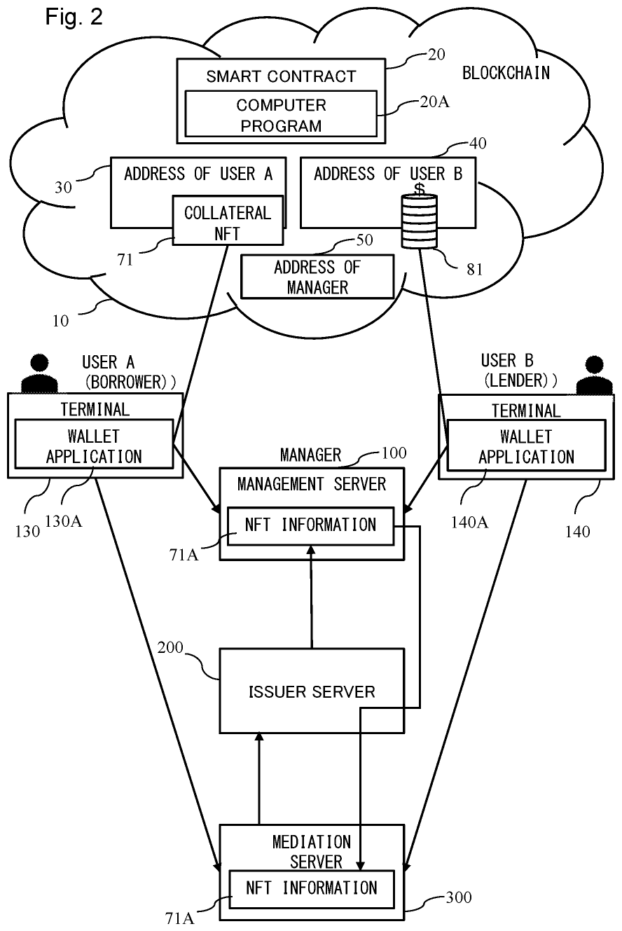

A smart contract 20 is implemented on a blockchain 10 shown in FIG. 2. The blockchain 10 is constituted by a P2P computer network. That is, the borrowing and lending process shown in FIG. 1 may be executed by a computer system constructing the blockchain. Moreover, a computer program for causing the computer system to function as the smart contract 20 is installed in the computer system that executes the borrowing and lending process. In this embodiment, the computer system for executing the process for keeping and returning a digital asset may include one or a plurality of computers in the computer network constituting the smart contract.

The computer system executing the borrowing and lending process may further include other computers. For example, the computer system may further include at least one computer selected from the group consisting of a management server 100, an issuer server 200, and a mediation server 300 which are described later. The computer system may include the management server 100 and the mediation server 300. The computer system may include all of the management server 100, the issuer server 200, and the mediation server 300.

In this embodiment, an object to be borrowed and lent is a digital asset that can be transacted on the computer network to which the computer system of the embodiment is connected. The computer network described here is the Internet, for example. The computer network may include a computer network constituting the blockchain 10, for example. The computer network may include computers outside the blockchain 10.

The digital asset may be legal currency or other money, but, preferably, is a crypto-asset (virtual currency) available on the blockchain 10. The crypto-asset available on the blockchain 10 can be easily operated by the smart contract 20. That is, preferably, the digital asset can be transacted on the blockchain 10. In this case, transaction of the digital asset is recorded on the blockchain 10 so as to be referable. The digital asset may be called a token.

The digital asset may be fungible or non-fungible. A fungible digital asset is also called a fungible token (FT). A non-fungible digital asset is also called a non-fungible token (NFT). A non-fungible token may be issued in association with a real asset. In this case, the substance of value resides not in the non-fungible token as the digital asset, but in the real asset. In this disclosure, it is defined that a non-fungible token associated with a valuable real asset is also a digital asset.

With borrowing and lending, an operation for keeping and returning the digital asset is executed in the smart contract 20 (specifically, the computer system functioning as the smart contract). That is, in this embodiment, an object to be borrowed and lent is a digital asset. In this embodiment, when a user A, who is a borrower, borrows money, the smart contract 20 keeps a digital asset owned by the user A as a collateral for repayment of a borrowing. The digital asset to be kept as the collateral is, for example, a non-fungible token (NFT) that can be transacted on the blockchain 10.

In this embodiment, when a user B, who is a lender, lends money, the smart contract 20 keeps a digital asset owned by the user B as a loan. The digital asset to be kept as the loan is, for example, a fungible token (FT) that can be transacted on the blockchain 10, and preferably is a crypto-asset (virtual currency) that can be transacted on the blockchain 10. In this embodiment, the loan being kept for the user B becomes the borrowing to be borrowed by the user B.

As described above, the digital asset (token) to be kept by the smart contract 20 may be a fungible token (FT) or a non-fungible token (NFT). The digital asset kept by the smart contract 20 is returned when the smart contract 29 has determined that a digital asset return condition is satisfied.

In this embodiment, the blockchain 10 is Ethereum, for example. A crypto-asset (virtual currency) used for Ethereum is called Ether. Ether can be used for payments and the like, and is exchangeable with legal currency. Thus, Ether has the property of currency. Ether has fungibility like legal currency, and therefore is a kind of fungible token.

In this embodiment, money (digital asset) to be borrowed and lent is preferably a fungible token such as Ether. That is, a borrowing and a loan are preferably fungible tokens. A fungible token can be used for payment of a price and the like, and is exchangeable with legal currency. In FIG. 1, the user A as the borrower can borrow a fungible token he/she needs, and the user B as the lender can lend a fungible token he/she can afford to lend.

An object to be borrowed is called a borrowing while an object to be lent is called a loan. Fungible tokens to be borrowed and lent (borrowing and loan) may be stablecoins available on the blockchain 10. A stablecoin is a crypto-asset whose price is relatively stable. The stablecoin may be a fiat-backed stablecoin or a cryptocurrency-backed stablecoin. An example of the fiat-backed stablecoin is PAX. An example of the cryptocurrency-backed stablecoin is DAI. The stablecoin also has fungibility, and therefore is regarded as a fungible token.

As for tokens (Ethereum tokens) available on the blockchain 10 such as Ethereum, there is a non-fungible token (NFT) as described above in addition to the fungible token. Tokens to be borrowed and lent (objects to be borrowed and lent) may be non-fungible tokens.

In contrast to the fungible token (FT), the non-fungible token (NFT) is a token having no fungibility. Since the NFT has no fungibility, an NFT may be different in value from other NFTs. The NFT is issued as a digital asset to be transacted in a computer game, for example. The NFT may have a unique value distinguishable from other NFTs. Therefore, the NFT has a unique identifier that enables the NFT to be distinguishable from other NFTs. The identifier of the NFT is also called “NFT-ID”, for example. Meanwhile, the fungible token such as Ether is the same in value as other fungible tokens and is not required to be distinguished, and therefore does not have an identifier such as an NFT-ID.

The NFT also has an address. The address is an Ethereum address, for example. The Ethereum address is composed of a plurality of alphanumeric characters beginning with Ox. The address of an NFT is unique to the NFT, and therefore can also serve as an identifier.

Like the fungible token, the NFT can be transacted on the blockchain 10. A transaction history of the NFT is recorded on the blockchain 10. The owner of the NFT and an owner history are also recorded on the blockchain 10.

The NFT is a token issued according to Ethereum Request for Comments (ERC) 721, for example. The NFT based on the ERC 721 is called an NFT-721 token. In this embodiment, the NFT-721 token is adopted as an example of the NFT.

In this embodiment, an NFT 71 owned by the user A as the borrower is used as a collateral (pledge) for repayment of a borrowing. The NFT 71 as the collateral is a valuable game item, for example. When the user A as the borrower has repaid the borrowing, the NFT 71 as the collateral (collateral NFT) is returned to the user A.

The NFT 71 can be subjected to transaction (owner change), and has a unique value. Since the owner and the transaction history of the NFT 71 are recorded on the blockchain 10, the NFT 71 is effective as the collateral. Moreover, since the NFT 71 is managed on the blockchain 10, the NFT 71 is not likely to be a fake or stolen token and therefore is effective as the collateral. Using the valuable NFT 71 as the collateral eliminates the necessity of checking the credit of the borrower.

In this embodiment, the NFT is used not only as the collateral 71 but also as certificates 72, 73 (certificate NFTs) that certify borrowing and lending, respectively. Using the NFT as the collateral 71 and the certificates 72, 73 enables borrowing and lending using the blockchain 10 to be smoothly executed.

In this embodiment, the certificate NFTs 72, 73 also serve as deposit certificates of the digital assets (collateral NFT 71, loan 81) deposited in the smart contract 20. The certificate NFTs 72, 73 indicate the rights to have the deposited digital assets 71, 81 back. That is, the owners of the certificate NFTs 72, 73 are holders of the rights to have the deposited digital assets 71, 81 back. The owners of the certificate NFTs 72, 73 are recorded on the blockchain 10 so as to be referable. Therefore, referring to the blockchain 10 allows acquisition of information (e.g., owner accounts) related to the owners of the certificate NFTs 72, 73.

The owners of the certificate NFTs 72, 73 are recorded on the blockchain 10 so as to be referable, and therefore can be easily checked. Moreover, since the holders of the rights to have the digital assets 71, 81 back are recorded on the blockchain 10, the smart contract 20 and the other computers constituting the computer system of the embodiment need not store or manage the holders of the rights to have the digital assets 71, 81 back, which is advantageous.

The smart contract 20 determines whether or not the return condition for the collateral NFT 71 (collateral digital asset) has been satisfied, and returns the deposited collateral NFT 71 to the owner of the certificate NFT 72 when the return condition has been satisfied. That is, when the return condition has been satisfied, the smart contract 20 transmits the collateral digital asset 71 to the owner of the certificate NFT 72. The return condition will be described later.

Since the certificate NFT 72 can be subjected to transaction (owner change) on the computer network, the owner of the certificate NFT 72 is changeable. That is, a subject having the right to have the collateral NFT 71 back is changeable. Change of the owner is recorded on the blockchain 10. The collateral NFT 71 is transmitted to the owner of the certificate NFT 72 at the time when the return condition has been satisfied.

As described above, when the return condition for the collateral NFT 71 has been satisfied, such as when the user A as the borrower has made repayment by the due date, the collateral NFT 71 is returned to the user A. However, the return destination of the collateral NFT 71 is not limited to the user A, and may be an assignee of the certificate NFT 72.

When a condition for transferring the collateral NFT 71 to the owner of the certificate NFT 73 (foreclosure condition for the deposited digital asset 71) has been satisfied, the smart contract 20 transmits the deposited digital asset 71 to the owner of the certificate NFT 73. The foreclosure condition will be described later.

Since the certificate NFT 73 can be transacted on the computer network, the owner of the certificate NFT 73 is changeable. That is, a subject having the right to have the loan 81 back is changeable. Change of the owner is recorded on the blockchain 10. A repayment for the loan 81 is transmitted to the owner of the certificate NFT 73 at the time when the return condition has been satisfied.

As described above, when the return condition for the loan 81 (the condition for return of the loan from the smart contract 20) has been satisfied, such as when the user A or the like has repaid the loan 81 by the due date, the loan 81 is returned to the user B. However, the return destination of the loan 81 is not limited to the user B, and may be an assignee of the certificate NFT 73.

The owners of the certificate NFTs 72, 73 can buy and sell the certificate NFTs 72, 73 on an NFT market using a computer network, for example. That is, the right to have the collateral NFT 71 or the loan 81 back can be bought and sold.

As shown in FIG. 2, the blockchain 10 such as Ethereum has addresses 30, 40, 50 for managing tokens (crypto-asset) such as the fungible token 81 and the NFT 71. In Ethereum, these addresses 30, 40, 50 are called Ethereum addresses. The addresses 30, 40, 50 for managing the crypto-asset also serve as user accounts on the blockchain 10. The addresses (accounts) 30, 40, 50 on the blockchain 10 are associated with fungible tokens or NFTs owned by the users.

On the blockchain 10 shown in FIG. 2, the address 30 of the user A, the address 40 of the user B, and the address 50 of a manager are shown. The fungible token 81 or the NFT 71 are transacted (transferred) among these addresses 30, 40, 50. Each address is also referred to as an account. In the following description, the user A is a borrower, and has the address 30 (account of the user A). The user B is a lender, and has the address 40 (account of the user B). The manager (management company) manages mediation between borrowing and lending, and has the address 50 (account of the manager).

The user A as the borrower owns the NFT 71 (collateral NFT) that can be a collateral. On the blockchain 10, the NFT 71 is associated with the address 30 of the user A. The user B as the lender owns the fungible token (loan) 81 that is lendable. The fungible token 81 is associated with the address 40 of the user B.

The user A and the user B can refer to the tokens 71, 81 associated with their addresses 30, 40 via, for example, wallet applications 130A, 140A for managing the crypto-asset, respectively. The wallet applications 130A, 140A are installed in, for example, terminals 130, 140 of the users A, B. Examples of the terminals 130, 140 include smartphones, tablets, and personal computers. The wallet applications 130A, 140A cause the terminals 130, 140 to display the tokens 71, 81 associated with the addresses 30, 40, respectively. By using the wallet applications 130A, 140A, the users A, B can perform an operation related to the tokens 71, 81, such as transaction (e.g., transmission) of the tokens 71, 81 associated with the addresses 30, 40, respectively.

The operation related to the tokens 71, 81 is, for example, an operation in which the user A transmits his/her token 71 to the user B. When this operation is performed with the wallet application 130A, the token 71 is transmitted from the address 30 of the user A (account of the user A) on the blockchain 10 to the address 40 of the user B (account of the user B) on the blockchain 10.

The manager can also access the blockchain 10 via the management server 100, and refer to and transact tokens associated with the address 50. The management server 100 is communicable with the issuer server 200 for the NFT 71 as the collateral via the network. The management server 100 is constituted by a computer including a processor and a memory connected to the processor. The memory stores therein a computer program. The computer program being executed by the processor causes the computer to operate as the management server 100.

The issuer server 200 is, for example, a server of an administrator of an online game in which the NFT 71 as a game item is issued. The issuer server 200 is constituted by a computer including a processor and a memory connected to the processor. The memory stores therein a computer program. The computer program being executed by the processor causes the computer to operate as the issuer server 200. The issuer server 200 may be operated by the manager of the management server 100, or a person other than the manager (e.g., the administrator of the online game).

The management server 100 can acquire information 71A (NFT information) related to the NFT 71 to be collateral, from the issuer server 200 via the network. The NFT information 71A is, for example, an image associated with the NFT 71. When the NFT 71 is a game item, the above image is the image of the game item. The image associated with the NFT 71 may be the image of the NFT 71 itself. The NFT information 71A may be another piece of information included in or associated with the NFT 71, such as information indicating the characteristics of the game item.

The NFT information 71A acquired by the management server 100 may be an NFT identifier. The NFT information acquired by the management server 100 may be at least one of an NFT-ID and an NFT address. The NFT information 71A acquired by the management server 100 may be both the NFT-ID and the NFT address.

The management server 100 may acquire the NFT information 71A from at least one selected from the group consisting of the smart contract 20, the issuer server 200, the mediation server 300, and the user terminal 130. The management server 100 may acquire the NFT information 71A from a plurality of locations.

For example, when the collateral NFT 71 is transmitted to the smart contract 20 to be deposited in the smart contract 20, the management server 100 can acquire the NFT information 71A from the smart contract 20. If the mediation server 300 has the NFT information 71A, the management server 100 may acquire the NFT information 71A from the mediation server 300.

In this embodiment, the mediation server 300 performs a process for matching of a borrower and a lender and matching of contract conditions. The mediation server 300 is managed by the aforementioned manager, for example. The mediation server 300 is a server on the Internet, for example, and a plurality of users who can be borrowers and lenders access the mediation server 300. The users can access the mediation server 300 via the wallet applications 130A, 140A installed in the terminals 130, 140, for example.

The user A who wants to be a borrower accesses the mediation server 300 via the terminal 130, and registers a contract condition draft for borrowing, in the mediation server 300. The contract condition draft may include, for example, the NFT 71 to be a collateral, the amount of money he/she wants to borrow, the interest, and the due date of repayment. Meanwhile, the user B who wants to be a lender accesses the mediation server 300 via the terminal 140, and registers a contract condition draft for lending, in the mediation server 300. The contract condition draft may include, for example, the amount of money he/she can lend, the interest, and the due date of repayment. The NFT information 71A of the NFT 71 to be the collateral may be registered in the mediation server 300.

The mediation server 300 has a function of displaying the NFT information 71A of the NFT 71 (collateral NFT) owned by the user A who wants to the borrower. The mediation server 300, if necessary, acquires the NFT information 71A from the management server 100 via the network. The mediation server 300 causes the user terminal to display the NFT information 71A so that other users can refer to the NFT information 71A.

The mediation server 300 has a function of a bulletin board, for example. The bulletin board is used by the users to determine a contract condition, and the users can refer to and write in the bulletin board. The contract condition agreed between the user A as the borrower and the user B as the lender is registered in the mediation server 300. The agreed contract condition may include data indicating, for example, the borrower, the lender, the amount of borrowing, the interest, and the due date of repayment. The contract condition may include an identifier for uniquely identifying each contract.

The mediation server 300 transmits the contract condition registered based on the agreement, to the smart contract 20 on the blockchain 10. According to the received contract condition, the smart contract 20 performs a process of causing the user A as the borrower and the user B as the lender to perform borrowing and lending (refer to FIG. 1). The registered contract condition is also transmitted to the management server 100.

The management server 100 can acquire, via the network, necessary information out of the information possessed by the mediation server 300 and the smart contract 20. The mediation server 300 can acquire, via the network, necessary information out of the information possessed by the management server 100 and the smart contract 20. The smart contract 20 can acquire necessary information out of the information possessed by the mediation server 300 and the management server 100.

The smart contract 20 is implemented on the blockchain 10 so as to automatically execute a protocol according to the received contract condition. The smart contract 20 according to the embodiment is implemented on the blockchain 10 by the manager.

The smart contract 20 is built when the computer program 20A is implemented on a computer network (computer system) constituting the blockchain 10. The computer program 20A is executed on the computer network (computer system) constituting the blockchain 10. The computer program 20A has a program code that defines an operation of the smart contract 20. The smart contract is operated when the computer program 20A is executed on the computer network (computer system) constituting the blockchain 10. The smart contract 20 is stored at an address (contract address) on the blockchain 10.

Referring back to FIG. 1, the mediation server 300 transmits the contract condition agreed between the user A as the borrower and the user B as the lender, to the smart contract 20 (step S41). The smart contract 20 receives the contract condition transmitted from the mediation server 300 (step S21).

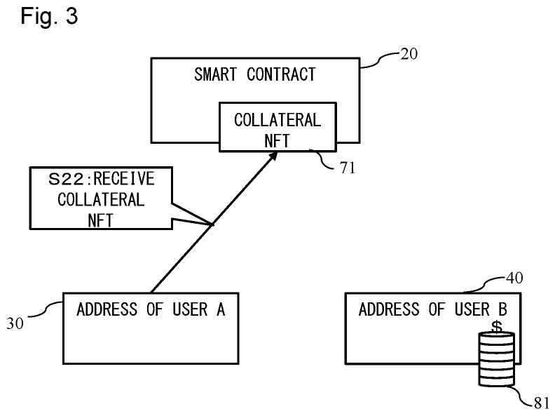

According to the contract condition, the user A as the borrower performs, by using the wallet application 130A (terminal 130), an operation of transmitting the NFT 71 to be a collateral (collateral NFT; first digital asset; first non-fungible token) to the smart contract 20 in order to deposit the NFT 71 in the smart contract 20 (step S11). This operation causes the collateral NFT 71 to be transmitted from the user A to the smart contract 20. The smart contract 20 receives the transmitted collateral NFT 71 (step S22). That is, as shown in FIG. 3, the collateral NFT 71 is transmitted from the address 30 (account) of the user A to the smart contract 20. Thus, the smart contract 20 enters the state of keeping the NFT 71 as the collateral deposited by the user A.

When the collateral NFT 71 has been transmitted to the smart contract 20, the certificate NFTs 72, 73 are generated. The certificate NFTs 72, 73 may be generated by the management server 100, the smart contract 20, or the management server 100 and the smart contract 20 in cooperation with each other. The timing to generate the certificate NFTs 72, 73 is not particularly limited. The certificate NFTs 72, 73 may be generated before transmission of the collateral NFT 71 to the smart contract 20, or after the transmission. Generation of the certificate NFTs 72, 73 is described below.

The certificate NFTs 72, 73 are generated in association with the collateral NFT 71. Therefore, each of the smart contract 20 and the computers constituting the computer system of the embodiment can identify the certificate NFT 72 associated with the collateral NFT 71, and can identify the certificate NFT 73 associated with the collateral NFT 71. Moreover, each of the smart contract 20 and the computers constituting the computer system of the embodiment can identify the collateral NFT 71 associated with the certificate NFT 72, and the collateral NFT 71 associated with the certificate NFT 73.

The certificate NFTs 72, 73 are generated in association with each other. Therefore, each of the smart contract 20 and the computers constituting the computer system of the embodiment can identify the certificate NFT 73 associated with the certificate NFT 72, and the certificate NFT 72 associated with the certificate NFT 73.

The certificate NFT 72 is generated in association with at least one of a borrowing and a loan. Therefore, each of the smart contract 20 and the computers constituting the computer system of the embodiment can identify the certificate NFT 72 associated with the borrowing or the loan, and can identify the borrowing or the loan associated with the certificate NFT 72.

The certificate NFT 73 is generated in association with at least one of the borrowing and the loan. Therefore, each of the smart contract 20 and the computers constituting the computer system of the embodiment can identify the certificate NFT 73 associated with the borrowing or the loan, and can identify the borrowing or the loan associated with the certificate NFT 73.

Association data indicating the respective associations described above may be stored in the certificate NFTs 72, 73, the management server 100, or the smart contract 20. The association data may be stored in a plurality of locations. The association data are referred to when the deposited digital asset (the collateral NFT 71, the loan 81) is returned.

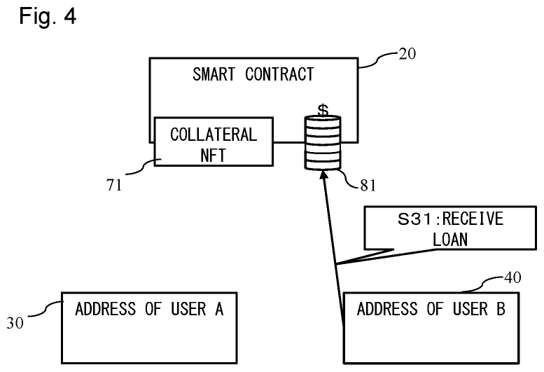

According to the contract condition, the user B as the lender performs, by using the wallet application 140A (terminal 140), an operation of transmitting a fungible token to be the loan 81 (principal) to the smart contract 20 (step S31). This operation causes the loan 81 to be transmitted from the user B to the smart contract 20. The smart contract 20 receives the transmitted loan 81 (step S23). That is, as shown in FIG. 4, the loan 81 is transmitted from the address 40 (account) of the user B to the smart contract 20. Thus, the smart contract 20 enters the state of keeping, for the user B, the loan 81 to be lent to the user A.

Reception of the loan from the user B may be performed before reception of the collateral NFT 71 from the user A.

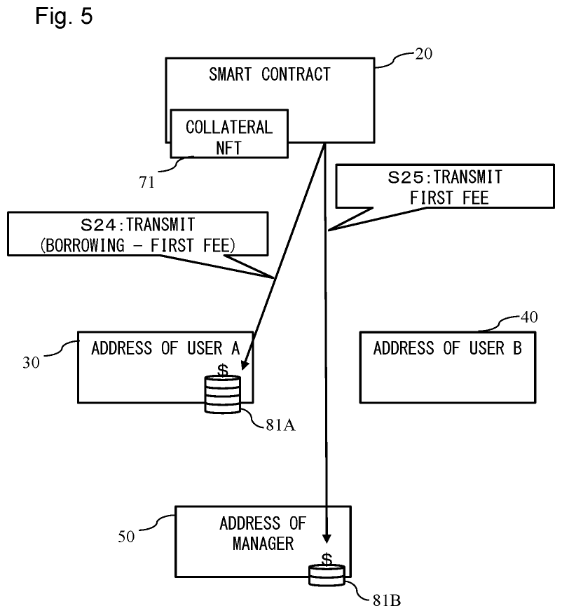

The smart contract 20, having received both the collateral NFT 71 and the loan 81, transmits, to the user A as the borrower, the loan 81 as a borrowing (principal) to be borrowed by the user A (step S24). The user A receives the transmitted borrowing 81A (step S12). That is, as shown in FIG. 5, the borrowing 81A is transmitted from the smart contract 20 to the address 30 of the user A. Thus, the user A enters the state of receiving the borrowing 81A.

In this embodiment, however, the borrowing 81A to be transmitted to the user A is not all but a part of the borrowing (principal). The remaining part of the borrowing is collected as a first fee 81B by the manager. The smart contract 20 transmits the first fee 81B to the manager (step S25). The manager receives the transmitted first fee 81B (step S42). That is, as shown in FIG. 5, the first fee 81B is transmitted from the smart contract 20 to the address 50 of the manager. Thus, the manager can get the first fee 81B. All of the borrowing may be transmitted to the user A.

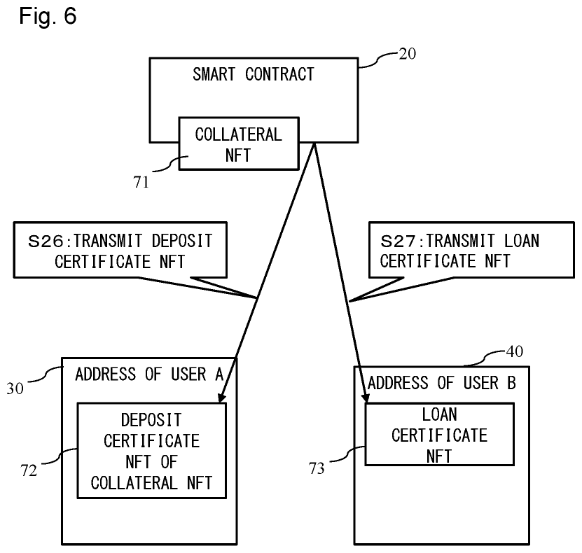

Upon receiving the collateral NFT 71, the smart contract 20 transmits, to the user A, the NFT 72 (deposit certificate NFT; borrowing certificate NFT; second non-fungible token) serving as a deposit certificate of the collateral NFT 71 (step S26). Transmission of the deposit certificate NFT 72 may be performed simultaneously with or after reception of the collateral NFT 71 by the smart contract 20, and may be performed before transmission of the borrowing to the user A. The user A receives the deposit certificate NFT 72 transmitted (step S13). That is, as shown in FIG. 6, the deposit certificate NFT 72 is transmitted from the smart contract 20 to the address 30 of the user A. Thus, the user A enters the state of receiving the deposit certificate NFT 72. In this embodiment, borrowing is completed when the user A has received the borrowing 81A and the deposit certificate NFT 72.

The deposit certificate NFT 72 allows the user A to certify that he/she is a holder of the right to have the collateral NFT 71 back through repayment of the borrowing (i.e., the owner of the deposit certificate NFT 72). In other words, the deposit certificate NFT 72 allows the user A to certify that he/she is a holder of the right to repossess the collateral NFT 71 through repayment of the borrowing (i.e., the owner of the deposit certificate NFT 72). Like other NFTs, the deposit certificate NFT 72 can be transferred to another person (owner change) on the blockchain 10. Therefore, when the deposit certificate NFT 72 is transmitted to another person (owner change), the right to repossess the collateral NFT 71 through repayment of the borrowing can be transferred to another person.

Upon receiving the loan 81, the smart contract 20 transmits, to the user B, the NFT 73 (loan certificate NFT; third non-fungible token) serving as a loan certificate (step S27). The loan certificate NFT 73 also serves as a loan deposit certificate indicating that the smart contract 20 is keeping the loan deposited therein. Transmission of the loan certificate NFT 73 may be performed simultaneously with reception of the loan 81 by the smart contract 20, after reception of the loan 81, or after transmission of the borrowing to the user A. The user B receives the transmitted loan certificate NFT 73 (step S32). That is, as shown in FIG. 6, the loan certificate NFT 73 is transmitted from the smart contract 20 to the address of the user B. Thus, the user B enters the state of receiving the loan certificate NFT 73. In this embodiment, lending is completed when the user B has transmitted the loan 81 and received the loan certificate NFT 73.

The loan certificate NFT 73 allows the user B to certify that he/she is a holder of the right to have the loan 81 back (the owner of the loan certificate NFT 73). In other words, the loan certificate NFT 73 allows the user B to certify that he/she is a holder of the right to receive repayment of the loan.

Moreover, the loan certificate NFT 73 allows the user B to certify that he/she is a holder of the right to acquire the collateral NFT 71 if repayment of the borrowing by the user A has not been made. Like other NFTs, the loan certificate NFT 73 can be transferred to another person (owner change) on the blockchain 10. Therefore, when the loan certificate NFT 73 is transmitted to another person (owner change), the right to receive repayment of the loan and the right to acquire the collateral NFT 71 if repayment has not been made, can be transferred to the other person.

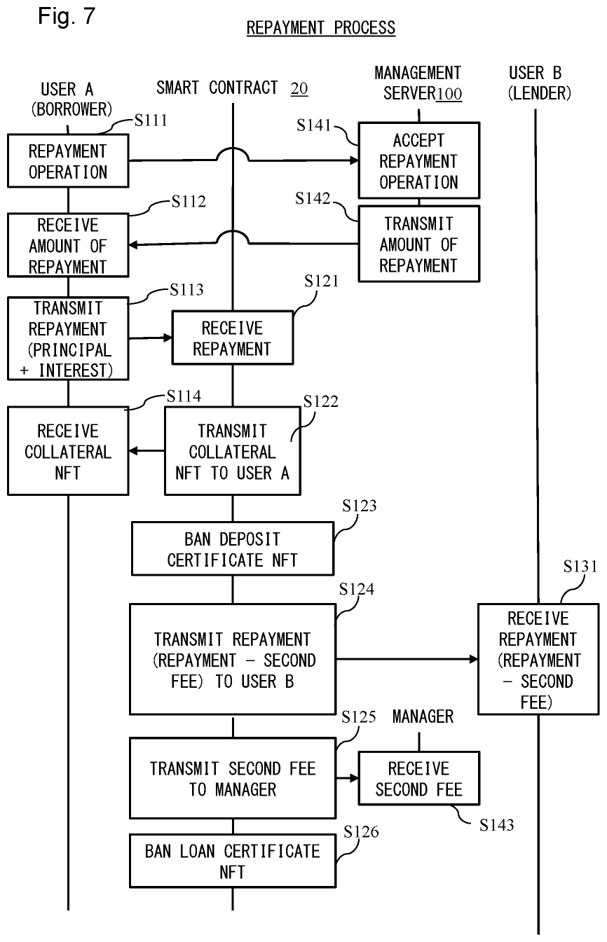

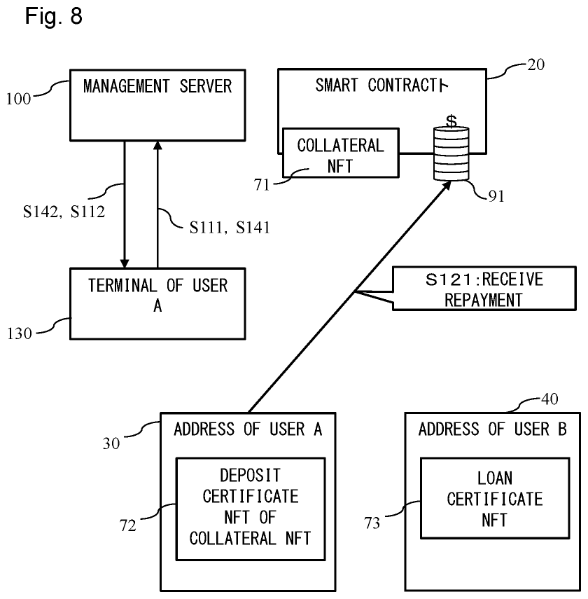

FIG. 7 shows a procedure of a borrowing repayment process. As shown in FIG. 8, the user A as the borrower performs a repayment operation by using the wallet application 130A (terminal 130) (step S111). The repayment operation can be performed before the due date of payment passes. The repayment operation is received by the management server 100 (step S141). Upon receiving the repayment operation, the management server 100 transmits the amount of repayment to the terminal 130 of the user A (step S142). The amount of repayment is, for example, the borrowing (principal) to which the interest up to the due date is added. The terminal 130 receives the amount of repayment (step S112). This allows the user A to know the amount of repayment.

In order to have the collateral NFT 71 back, the user A transmits a fungible token to be a repayment 91 to the smart contract 20 (step S113). The smart contract 20 receives the transmitted repayment 91 (step S121). That is, as shown in FIG. 8, the repayment 91 is transmitted from the address 30 of the user A to the smart contract 20. Thus, the smart contract 20 enters the state of keeping the repayment 91.

When the fungible token as the repayment 91 is transmitted to the smart contract 20, the deposit certificate NFT 72 may also be transmitted from the address of the user A to the smart contract 20.

Upon receiving the repayment 91, the smart contract 20 transmits the collateral NFT 71 having been kept therein (step S122). The smart contract 20 identifies the collateral NFT 71 corresponding to the repayment 91, and transmits the identified collateral NFT 71. The smart contract 20 identifies the NFT 71 corresponding to the repayment 91, based on the deposit certificate NFT 72 transmitted together with the repayment 91, for example. The collateral NFT 71 corresponding to the repayment 91 may be notified to the smart contract 20 through a user operation.

In advance of transmission of the collateral NFT 71, the smart contract 20 identifies the transmission destination of the collateral NFT 71. The transmission destination of the collateral NFT 71 is the owner account of the deposit certificate NFT 72. The smart contract 20 refers to the blockchain 10 to identify the owner account of the deposit certificate NFT 72. The smart contract 20 may identify the transmission source of the received deposit certificate NFT 72, as the owner account of the deposit certificate NFT 72.

If the owner of the deposit certificate NFT 72 is the user A, the smart contract 20 transmits the collateral NFT 71 to the account of the user A. Thus, in this embodiment, the collateral NFT 71 is returned to the owner of the deposit certificate NFT 72 associated with the collateral NFT 71. In this embodiment, the smart contract 20 returns the collateral NFT 71 to the transmission source of the deposit certificate NFT 72. In this embodiment, the smart contract 20 need not store or manage the return destination of the collateral NFT 71, which is advantageous.

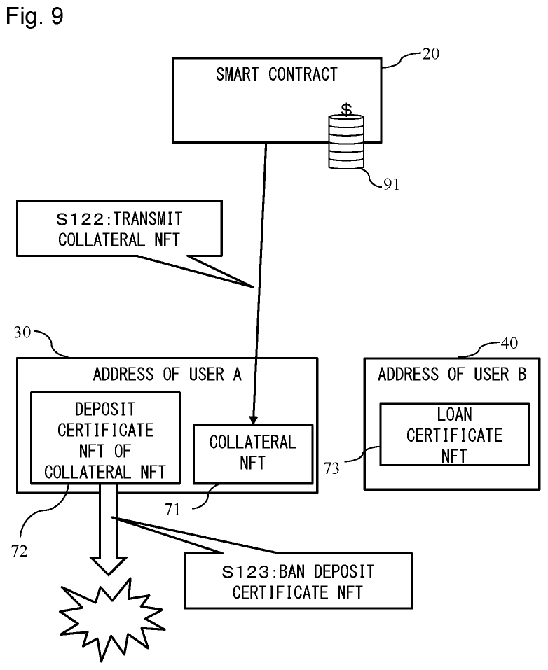

The user A receives the transmitted collateral NFT 71 (step S114). That is, as shown in FIG. 9, the collateral NFT 71 is transmitted from the smart contract 20 to the address 30 of the user A. Thus, the user A enters the state of receiving the returned collateral NFT 71.

In this embodiment, the return condition for the collateral NFT 71 is that the smart contract 20 has received the repayment 91. Upon receiving the repayment 91, the smart contract 20 determines that the return condition for the collateral NFT 71 has been satisfied, and returns the collateral NFT 71. The return condition for the collateral NFT 71 may be that the smart contract 20 has received the certificate NFT 72. The return condition for the collateral NFT 71 may be that the smart contract 20 has received the repayment 91 and the certificate NFT 72.

The smart contract 20 bans the certificate NFT 72 simultaneously with or after transmission of the collateral NFT 71 (step S123). The phrase “bans the certificate NFT 72” means that the NFT 72 is made incapable of being transacted on the blockchain 10. Making the NFT 72 incapable of being transacted on the blockchain 10 may be making the NFT 72 disappear on the blockchain 10. Making the NFT 72 incapable of being transacted on the blockchain 10 may be that the smart contract 20 continues to hold the NFT 72. If the smart contract 20 does not hold the NFT 72 to be banned, the NFT 72 may be compulsorily transmitted to the smart contract 20.

Making the NFT 72 incapable of being transacted on the blockchain 10 may be that the smart contract 20 transmits the NFT 72 to an address (account) at which no users can make a transaction.

Upon receiving the repayment 91 for the loan 81 from the user A as the borrower, the smart contract 20 identifies the transmission destination of the repayment 91, and transmits the repayment 91A to the identified destination (e.g., the borrower B) (step S124). The smart contract 20 identifies the owner account of the loan certificate NFT 73 corresponding to the repayment 91 (loan 81) as the transmission destination of the repayment 91A. For example, the smart contract 20 identifies the loan certificate NFT 73 corresponding to the repayment 91 (loan 81), and identifies the owner of the loan certificate NFT 73 as the transmission destination of the repayment 91. The owner of the loan certificate NFT 73 can be identified by referring to the blockchain 10. The smart contract 20 may identify the loan certificate NFT 73 associated with the deposit certificate NFT 72 transmitted to the smart contract 20 together with the repayment 91, and may identify the owner of the loan certificate NFT 73 as the transmission destination of the repayment 91. The smart contract 20 may identify the loan certificate NFT 73 associated with the transmitted collateral NFT 71, and may identify the owner of the loan certificate NFT 73 as the transmission destination of the repayment 91. The loan certificate NFT 73 corresponding to the repayment 91 (loan 81) may be notified to the smart contract 20 through a user operation.

If the owner of the loan certificate NFT 73 is the user B, the smart contract 20 transmits the repayment 91A (money equivalent to the loan 81) to the account of the user B. Thus, in this embodiment, the loan 81 lent by the user B is returned to the owner of the loan certificate NFT 73 associated with the loan 81. In this embodiment, the smart contract 20 returns the loan 81 to the owner of the loan certificate NFT 73 corresponding to the deposit certificate NFT 72 or the owner of the loan certificate NFT 73 corresponding to the collateral NFT 71. In this embodiment, the smart contract 20 need not store or mange the return destination of the loan 81, which is advantageous.

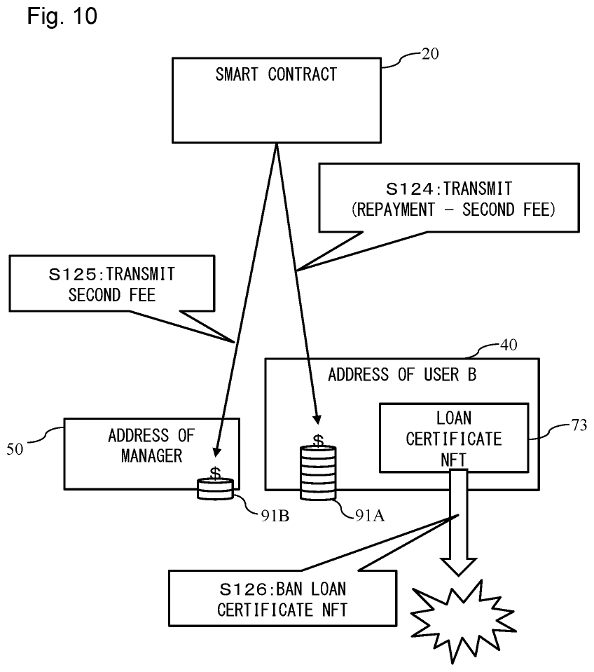

The user B receives the transmitted repayment 91A (step S131). That is, as shown in FIG. 10, the repayment 91A is transmitted from the smart contract 20 to the address 40 of the user B. Thus, the user B enters the state of receiving the repayment of the loan. That is, the user B enters the state of having the loan 81 returned.

In this embodiment, however, the repayment 91A transmitted to the user B is not all but a part of the repayment. The remaining part of the repayment is collected as a second fee 91B by the manager. The smart contract 20 transmits the second fee 91B to the manager (step S125). The manager receives the transmitted second fee 91B (step S143). That is, as shown in FIG. 10, the second fee 91B is transmitted from the smart contract 20 to the address 50 of the manager. Thus, the manager gets the second fee. All of the repayment may be transmitted to the user B.

The condition for reception of the repayment 91A by the user B as the owner of the loan certificate NFT 73 may be that the loan certificate NFT 73 has been transmitted from the account of the user B to the smart contract 20. That is, the loan certificate NFT 73 may be transmitted from the account of the user B to the smart contract 20 simultaneously with or before transmission of the repayment 91A by the smart contract 20.

In this embodiment, the return condition for the loan 81 is that the smart contract 20 has received the repayment 91. Upon receiving the repayment 91, the smart contract 20 determines that the return condition for the loan 81 has been satisfied, and returns the loan 81. The return condition for the loan 81 may be that the smart contract 20 has received the certificate NFT 73. The return condition for the loan 81 may be that the smart contract 20 has received the repayment 91 and the certificate NFT 73.

The smart contract 20 bans the loan certificate NFT 73 simultaneously with or after transmission of the repayment 91A (step S126). The banning method is the same as that for the NFT 72.

The repayment process is completed through the above steps.

In this embodiment, a person who repays the borrowing is not limited to the user A as the borrower, and may be any person as long as he/she is the owner (first owner) of the deposit certificate NFT 72. That is, the owner of the deposit certificate NFT 72 has an obligation to repay the borrowing. If the deposit certificate NFT 72 is assigned with or without a charge from the borrower to another person (owner change), the person who is an assignee of the deposit certificate NFT 72 becomes the new owner (first owner) of the deposit certificate NFT 72. In this embodiment, the smart contract 20 may be configured to receive the repayment only from the owner of the deposit certificate NFT 72.

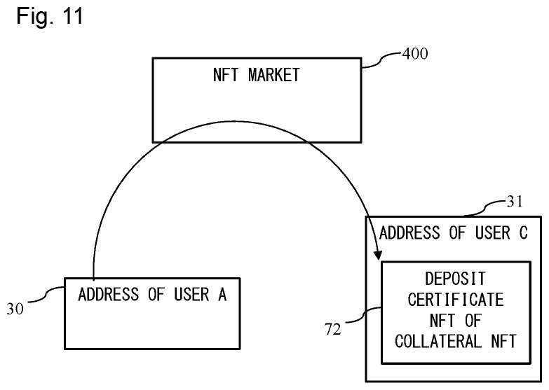

As shown in FIG. 11, in an NFT market 400, the user A as the borrower can make an agreement for sale (assignment) of the deposit certificate NFT 72 with a user C. The NFT market 400 is, for example, a website for NFT transaction. In this case, the deposit certificate NFT 72 is transmitted from the address 30 (account) of the user A to an address 31 (account) of the user C. Thus, the user C becomes the new owner (first owner) of the deposit certificate NFT 72.

The user C can acquire the collateral NFT 71 by repaying the borrowing according to the repayment procedure shown in FIG. 7, as the owner of the deposit certificate NFT 72 instead of the user A. A person who has accepted assignment of the deposit certificate NFT 72 from the user C can also repay the borrowing.

In this embodiment, a person who receives repayment of the borrowing is not limited to the user B as the lender, and may be any person as long as he/she is the owner (second owner) of the loan certificate NFT 73. That is, the owner of the loan certificate NFT 73 has the right to receive repayment of the loan, and the right to acquire the collateral NFT 71 if repayment has not been made. If the loan certificate NFT 73 is assigned with or without a charge from the lender to another person (owner change), the person who is an assignee of the loan certificate NFT 73 becomes the new owner (second owner) of the loan certificate NFT 73.

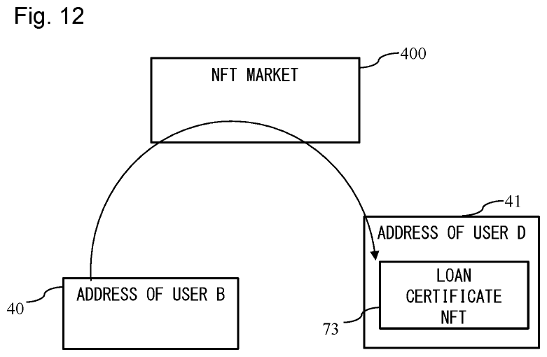

As shown in FIG. 12, in the NFT market 400, the user B as the lender can make an agreement for sale (assignment) of the loan certificate NFT 73 with a user D. The NFT market 400 is, for example, a website for NFT transaction. In this case, the loan certificate NFT 73 is transmitted from the address 40 (account) of the user B to an address 41 (account) of the user D. Thus, the user D becomes the new owner (second owner) of the loan certificate NFT 73.

The user D can receive a repayment according to the repayment procedure shown in FIG. 7, as the owner of the loan certificate NFT 73 instead of the user B. If repayment has not been made, the user D can receive the collateral NFT 71 as described later. A person who has accepted assignment of the loan certificate NFT 73 from the user D can also receive the repayment and the collateral NFT 71.

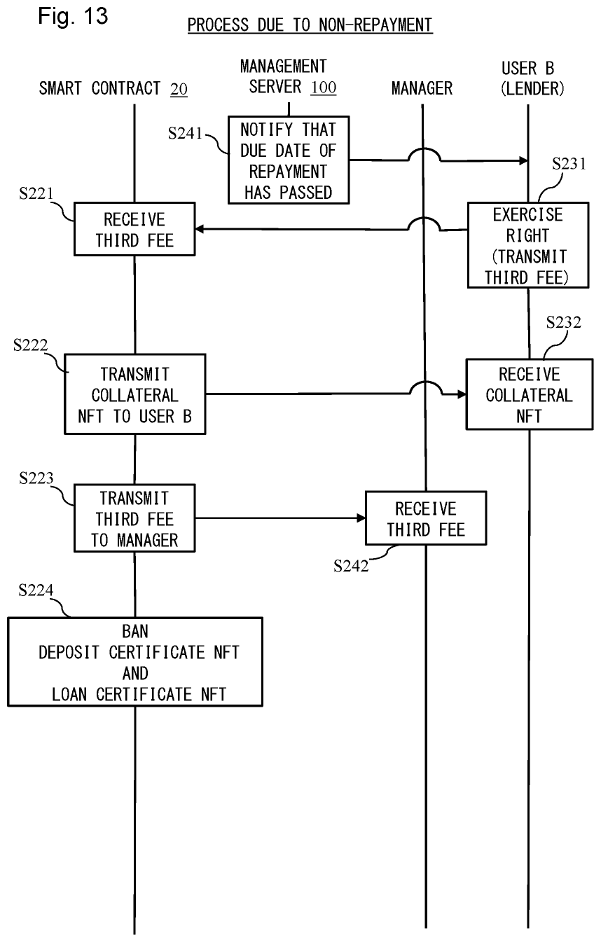

FIG. 13 shows a process due to non-repayment (foreclosure). This process is executed if repayment has not been made by the due date. In this process, the collateral NFT 71 being kept by the smart contract 20 is transmitted to the user B as the lender (the second owner of the loan certificate NFT 73).

Firstly, upon detecting that the due date of repayment in the contract condition has passed, that is, repayment has not been made, the management server 100 transmits, to the user B as the lender (the second owner of the loan certificate NFT 73), a notification that the due date of repayment has passed (step S241). The management server 100 can grasp the current second owner of the loan certificate NFT 73 through a process of referring to the owner of the loan certificate NFT 73 on the blockchain 10.

Upon receiving the notification that the due date of repayment has passed, the user B grasps that he/she becomes able to acquire the collateral NFT 71. In order to exercise the right to acquire the collateral NFT 71, the user B transmits a fungible token to be a third fee to the smart contract 20 (step S231). The third fee is a fee to be paid to the manager in order to acquire the collateral NFT 71.

Upon receiving the third fee (step S221), the smart contract 20 transmits the collateral NFT 71 to the user B. That is, the collateral NFT 71 is transmitted from the smart contract to the address of the user B.

The user B receives the collateral NFT 71 transmitted from the smart contract 20 (step S232). Thus, the user B can acquire the collateral NFT 71 instead of receiving the repayment.

When the third fee is transmitted to the smart contract 20, the certificate NFT 73 may also be transmitted to the smart contract 20.

In this embodiment, when the due date of repayment in the contract condition has passed and the smart contract 20 has received the third fee, the smart contract 20 determines that the foreclosure condition, i.e., receiving the third fee after the due date of repayment has passed, is satisfied, and transmits the collateral NFT 71 to the address of the user B. The foreclosure condition may be that the due date of repayment in the contract condition has passed. The foreclosure condition may be that the third fee has been received. The foreclosure condition may be that the certificate NFT 73 has been received. The foreclosure condition may be that the third fee and the certificate NFT 73 have been received. The foreclosure condition may be that the owner of the certificate NFT 72 has abandoned the collateral NFT 71. The foreclosure condition may be that the owner of the certificate NFT 72 has abandoned the collateral NFT 71 and the third fee and the certificate NFT 73 have been received.

Upon receiving the third fee (step S221), the smart contract 20 transmits the third fee to the manager (step S223). The manager receives the third fee (step S242).

The smart contract 20 bans the deposit certificate NFT 72 and the loan certificate NFT 73 simultaneously with or after transmission of the collateral NFT 71 (step S224). The banning method is the same as described above.

The process due to non-repayment is completed through the above steps.

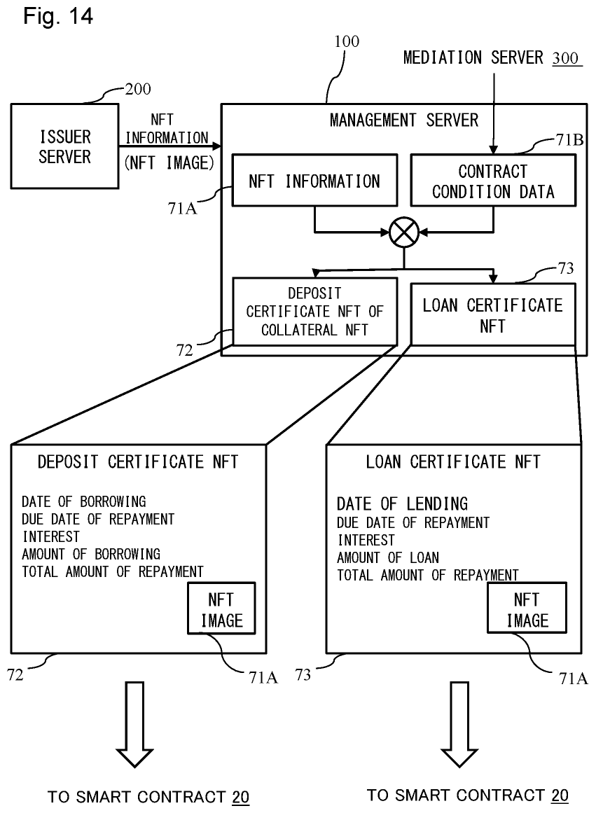

FIG. 14 shows how to generate the deposit certificate NFT 72 and the loan certificate NFT 73 (NFT generation process). In the NFT generation process, the deposit certificate NFT 72 and the loan certificate NFT 73 may be generated simultaneously or at different timings. For example, the NFT generation process is triggered by a digital asset such as the collateral NFT 71 being received. For example, when the smart contract 70 has received the digital asset such as the collateral NFT 71, the NFT generation process is triggered by the reception.

In this embodiment, the deposit certificate NFT 72 (second non-fungible token) and the loan certificate NFT 73 (third non-fungible token) are issued by the management server 100, for example. Thus, the management server 100 is used for the NFT generation process. The management server 100 according to the embodiment is used in the method of keeping and returning the digital asset. The management server 100 according to the embodiment is used in the method of managing borrowing and lending. The management server 100 is provided with a processor that operates to issue the second non-fungible token 72 and the third non-fungible token 73 from data 71A related to the first non-fungible token 71, and to transmit the second non-fungible token 72 and the third non-fungible token 73 to the smart contract 20. That is, the management server 100 issues the certificate NFTs 72, 73 associated with the collateral NFT 71. The management server 100 issues the certificate NFTs 72, 73 associated with at least one of the borrowing and the loan. The issued NFTs 72, 73 are transmitted according to the transmission process performed by the smart contract 20.

The management server 100 determines information (data) to be added to the generated NFTs 72, 73, based on the collateral NFT as a digital asset or on the loan. For example, the management server 100 issues the deposit certificate NFT 72 and the loan certificate NFT 73 by using the NFT information 71A (data related to the first non-fungible token). The NFT information 71A includes an image of the collateral NFT 71, for example. In order to add the image of the collateral NFT 71 to the NFTs 72, 73, the image of the collateral NFT 71 is acquired in the NFT generation process. The image is acquired from the aforementioned issuer server 200, for example. The image stored in the management server 100 may be acquired. The NFT information may include the identifier of the NFT.

In this embodiment, the management server 100 issues the deposit certificate NFT 72 and the loan certificate NFT 73 by also using contract condition data 71B. The management server 100 acquires the contract condition data 71B from the mediation server 300, for example. The contract condition data 71B includes, for example, the NFT_ID (NFT identifier) of the collateral NFT 71, the date of borrowing (the date of lending), the due date of repayment, the interest, the amount of borrowing (the amount of loan), and the total amount of repayment.

Upon acquiring the contract condition data 71B from the mediation server 300, the management server 100 combines the NFT information 71A of the collateral NFT 71 with the contract condition data 71B to generate the deposit certificate NFT 72 associated with the collateral NFT 71. The generated deposit certificate NFT 72 includes the information related to the collateral NFT 71 and the contract condition. That is, the deposit certificate NFT 72 includes data related to the collateral NFT 71 as the digital asset. Therefore, a third party referring to the deposit certificate NFT 72 can grasp the information related to the collateral NFT 71 and the contract condition. As a result, smooth transaction of the deposit certificate NFT 72 can be performed.

Upon acquiring the contract condition data 71B from the mediation server 300, the management server 100 combines the NFT information 71A of the collateral NFT 71 with the contract condition data 71B to generate the loan certificate NFT 73 associated with the collateral NFT 71 or the loan. That is, the loan certificate NFT 73 includes data related to the collateral NFT 71 as a digital asset. Moreover, the loan certificate NFT 73 includes data related to the loan as a digital asset.

The generated loan certificate NFT 73 indicates the information related to the collateral NFT 71 and the contract condition (including data related to the loan). Therefore, the third party referring to the loan certificate NFT 73 can grasp the information related to the collateral NFT 71 and the contract condition. As a result, smooth transaction of the loan certificate NFT 73 can be performed.

The management server 100 transmits the generated deposit certificate NFT 72 and loan certificate NFT 73 to the smart contract 20. The smart contract 20 transmits the received deposit certificate NFT 72 to the borrower (the transmission source of the collateral NFT 71) (step S26 in FIG. 1). The smart contract 20 transmits the received loan certificate NFT 73 to the lender (the transmission source of the loan) (step S27 in FIG. 1).

The certificate NFTs 72, 73 may be generated in the smart contract 20 or any of other computers constituting the computer system of this embodiment. The generation process for the NFTs 72, 73 may be performed by an NFT generation smart contract that is different from the smart contract 20.

The present invention is not limited to the embodiment described above, and various modifications are possible.

### <3. Additional Notes>

The above embodiment also discloses a method of managing borrowing and lending, a method of managing borrowing, a method of managing lending, and a smart contract. The outlines thereof are organized as follows.

### <3.1. Outlines of Method of Managing Borrowing and Lending, Method of Managing Borrowing, Method of Managing Lending, and Smart Contract>

The present inventors have come up with an idea that borrowing and lending are managed by a smart contract. Since an execution history of the smart contract is recorded on a blockchain, transparency of a contract can be ensured when the smart contract is used.

Therefore, technical means for managing borrowing and lending by the smart contract is desired.

(1) A method according to an embodiment is a method of managing borrowing and lending by a smart contract operating on a blockchain. This method may include receiving, by the smart contract, a first non-fungible token owned by a borrower of a borrowing, as a collateral for repayment of the borrowing. Thus, the smart contract keeps the first non-fungible token as the collateral.

The above method may include transmitting, by the smart contract, a second non-fungible token as a deposit certificate of the first non-fungible token to the borrower. Thus, the borrower acquires the second non-fungible token as the deposit certificate instead of the collateral deposited in the smart contract.

The above method may include transmitting, by the smart contract, a third non-fungible token as a deposit certificate of a loan to a lender of the loan corresponding to the borrowing. Thus, the lender acquires the third non-fungible token as the deposit certificate of the loan.

According to the above method of the embodiment, management of borrowing and lending using the first non-fungible token, the second non-fungible token, and the third non-fungible token is realized.

(2) The above method may include receiving, by the smart contract, the loan from the lender. Thus, the smart contract keeps the loan.

The above method may include transmitting, by the smart contract, the loan as the borrowing to the borrower. Thus, the borrower acquires the borrowing instead of the collateral deposited in the smart contract.

(3) The method may further include transmitting, by the smart contract, a part of the borrowing, as a first fee, to a manager who is a third party other than the borrower and the lender. Thus, the manager gets the fee.

(4) The above method may further include, when the smart contract has received repayment of the borrowing from a first owner of the second non-fungible token, transmitting the first non-fungible token to the first owner, and banning the second non-fungible token. When the borrowing is repaid, the first non-fungible token as the collateral is returned, and the second non-fungible token as the deposit certificate of the collateral is banned.

(5) The first owner is preferably the borrower or an assignee of the second non-fungible token. The borrower or the assignee can repay the borrowing.

(6) The method may further include, when the smart contract has received repayment of the borrowing from the first owner of the second non-fungible token, transmitting the repayment to a second owner of the third non-fungible token, and banning the third non-fungible token. When the repayment has been made, the third non-fungible token as the deposit certificate of the loan is banned. The non-fungible token, once banned, cannot be subjected to transaction (owner change) anymore on the blockchain.

(7) The second owner is preferably the lender or an assignee of the third non-fungible token. The lender or the assignee can receive the repayment.

(8) The above method may further include transmitting, by the smart contract, a part of the repayment, as a second fee, to the manager who is a third party other than the borrower and the lender. Thus, the manager gets the fee.

(9) The above method may further include, when repayment of the borrowing has not been made, transmitting, by the smart contract, the first non-fungible token to the second owner of the third non-fungible token. Repayment having not been made refers to, for example, the due date of repayment having passed. Repayment having not been made includes, for example, declaration of non-repayment by the owner of the second non-fungible token.

(10) The above method may further include, when repayment of the borrowing has not been made and the smart contract has received the third fee from the second owner of the third non-fungible token, transmitting, by the smart contract, the first non-fungible token to the second owner of the third non-fungible token, and transmitting, by the smart contract, a part or all of the third fee to the manager who is the third party other than the borrower and the lender. Thus, the manager gets the fee.

(11) The above method may further include, when repayment of the borrowing has not been made, transmitting the first non-fungible token to the second owner of the third non-fungible token and banning the third non-fungible token, by the smart contract. Thus, the second owner acquires the first non-fungible token as the collateral, and the third non-fungible token as the deposit certificate of the loan is banned.

(12) The above method may further include banning, by the smart contract, the second non-fungible token when repayment of the borrowing has not been made. Thus, the second non-fungible token as the deposit certificate of the collateral is banned.

(13) The above method may further include: issuing, by a server accessible to the smart contract, the second non-fungible token and the third non-fungible token from data related to the first non-fungible token; and transmitting, by the server, the second non-fungible token and the third non-fungible token to the smart contract. In this case, the server can issue the second non-fungible token and the third non-fungible token.

(14) The borrowing and the loan are preferably fungible tokens. In this case, handling of the borrowing and the loan on the blockchain is facilitated.

In the present specification and claims, the order in which the steps constituting the method are described does not limit the order in which the steps are executed. That is, a method in which the order of executing the steps constituting the method is different from the order of describing the steps, may also be included.

(15) A method according to an embodiment is a method of managing borrowing by a smart contract operating on a blockchain. This method may include: receiving, by the smart contract, a first non-fungible token owned by a borrower of a borrowing, as a collateral for repayment of the borrowing; and transmitting, by the smart contract, a second non-fungible token as a deposit certificate of the first non-fungible token to the borrower.

(16) A method according to an embodiment is a method of managing lending by a smart contract operating on a blockchain. This method may include: receiving a loan from a lender by the smart contract; and transmitting, to the lender, a non-fungible token as a deposit certificate of the loan by the smart contract.

(17) A smart contract according to an embodiment is a smart contract implemented on a blockchain built on a computer network. The smart contract is preferably configured to execute an operation including: receiving a first non-fungible token owned by a borrower of a borrowing, as a collateral for repayment of the borrowing; and transmitting, to the borrower, a second non-fungible token as a deposit certificate of the first non-fungible token.

(18) A smart contract according to an embodiment is a smart contract implemented on a blockchain built on a computer network. The smart contract is preferably configured to execute an operation including: receiving a loan from a lender; and transmitting, to the lender, a non-fungible token as a deposit certificate of the loan.

### REFERENCE SIGNS LIST

10 blockchain

20 smart contract

20A computer program

30 address of user A

31 address of user C

40 address of user B

41 address of user D

50 address of manager

71 first non-fungible token (collateral NFT)

71A NFT information

71B contract condition data

72 second non-fungible token (deposit certificate NFT of collateral NFT)

73 third non-fungible token (loan certificate NFT; deposit certificate NFT of loan)

81 loan

81A borrowing

81B first fee

91 repayment

91A repayment

91B second fee

100 management server

130 terminal

130A wallet application

140 terminal

140A wallet application

200 issuer server

300 mediation server

400 NFT market

A user

B user

C user

D user

1. A method executed by a computer system in order to keep and return a first digital asset that can be transacted, the method comprising:
receiving, by the computer system, the first digital asset transmitted from an account of a user in order to keep the first digital asset for the user;
generating, by the computer system, a second non-fungible token that is associated with the first digital asset and whose owner is recorded on a blockchain;
transmitting, by the computer system, the second non-fungible token generated to the account of the user; and
when the computer system has determined that a return condition for the first digital asset is satisfied, transmitting, by the computer system, the first digital asset to an owner account of the second non-fungible token associated with the first digital asset in order to return the first digital asset.

2. The method according to claim 1, wherein
the blockchain is configured to record the owner account of the second non-fungible token, and
the computer system is configured to identify the owner account of the second non-fungible token associated with the first digital asset, by referring to the blockchain.

3. The method according to claim 1, wherein
the second non-fungible token generated by the computer system includes data related to the first digital asset.

4. The method according to claim 1, wherein
the first digital asset is a first non-fungible token whose transaction is recorded on the blockchain.

5. The method according to claim 4, wherein
keeping the first digital asset for the user is keeping, by the computer system, the first non-fungible token that is a collateral for repayment of a borrowing that the user borrows.

6. The method according to claim 1, wherein
the first digital asset is a first fungible token whose transaction is recorded on the blockchain.

7. The method according to claim 6, wherein
keeping the first digital asset for the user is keeping, by the computer system, the first fungible token as a loan that the user lends.

8. A method executed by a computer system, comprising:
receiving, by the computer system, a first non-fungible token transmitted from an account of a first user in order to keep a collateral for repayment of a borrowing that the first user borrows;
receiving, by the computer system, a loan that a second user lends and that is transmitted from an account of the second user, in order to keep the loan;
generating, by the computer system, a second non-fungible token that is associated with the first non-fungible token and whose owner is recorded on a blockchain, and a third non-fungible token that is associated with the loan and whose owner is recorded on the blockchain;
transmitting, by the computer system, the second non-fungible token generated, as a deposit certificate of the first non-fungible token to the account of the first user;
transmitting, by the computer system, the third non-fungible token generated, as a deposit certificate of the loan to the account of the second user;
when the computer system has determined that a return condition for the first non-fungible token is satisfied, transmitting, by the computer system, the first non-fungible token to an owner account of the second non-fungible token associated with the first non-fungible token in order to return the first non-fungible token; and
when the computer system has determined that a return condition for the loan is satisfied, transmitting, by the computer system, the loan to an owner account of the third non-fungible token associated with the loan in order to return the loan.

9. A computer system configured to execute a process for keeping and returning a first digital asset that can be transacted, the process comprising:
receiving, by the computer system, the first digital asset transmitted from an account of a user in order to keep the first digital asset for the user;
generating, by the computer system, a second non-fungible token that is associated with the first digital asset and whose owner is recorded on a blockchain;
transmitting, by the computer system, the second non-fungible token generated to the account of the user; and
when the computer system has determined that a return condition for the first digital asset is satisfied, transmitting, by the computer system, the first digital asset to an owner account of the second non-fungible token associated with the first digital asset in order to return the first digital asset.

10. A computer system configured to execute a process, the process comprising:
receiving, by the computer system, a first non-fungible token transmitted from an account of a first user in order to keep a collateral for repayment of a borrowing that the first user borrows;
receiving, by the computer system, a loan that a second user lends and that is transmitted from an account of the second user, in order to keep the loan;
generating, by the computer system, a second non-fungible token that is associated with the first non-fungible token and whose owner is recorded on a blockchain, and a third non-fungible token that is associated with the loan and whose owner is recorded on the blockchain;
transmitting, by the computer system, the second non-fungible token generated, as a deposit certificate of the first non-fungible token to the account of the first user;
transmitting, by the computer system, the third non-fungible token generated, as a deposit certificate of the loan to the account of the second user;
when the computer system has determined that a return condition for the first non-fungible token is satisfied, transmitting, by the computer system, the first non-fungible token to an owner account of the second non-fungible token associated with the first non-fungible token in order to return the first non-fungible token; and
when the computer system has determined that a return condition for the loan is satisfied, transmitting, by the computer system, the loan to an owner account of the third non-fungible token associated with the loan in order to return the loan.

11. A method comprising:
generating, by a computer system, a non-fungible token associated with a digital asset received; and
identifying, by the computer system, an owner of the non-fungible token as a transmission destination of the digital asset.

12. A computer system configured to execute a process, the process comprising:
generating a non-fungible token associated with a digital asset received; and
identifying an owner of the non-fungible token as a transmission destination of the digital asset.

13. (canceled)

14. (canceled)

15. (canceled)

16. (canceled)

17. (canceled)

18. The method according to claim 11, wherein the non-fungible token can be transacted on a blockchain, and an owner of the non-fungible token is recorded on the blockchain.

19. The method according to claim 11, wherein the digital asset is a non-fungible token.

20. The method according to claim 11, wherein the digital asset is a fungible token.
